(19) United States
(12) Patent Application Publication
(10) Pub. No.: US 2006/0227691 A1
(43) Pub. Date: Oct. 12, 2006

(54) Iterative stripwise trellis-based symbol detection method and device for multi-dimensional recording systems

(76) Inventors: Willem Maria Julia Marcel Coene, Eindhoven (NL); Andries Pieter Hekstra, Eindhoven (NL); Albert Hendrik Jan Immink, Eindhoven (NL)

Correspondence Address: PHILIPS INTELLECTUAL PROPERTY & STANDARDS, P.O. BOX 3001, BRIARCLIFF MANOR, NY, 10510, US

(21) Appl. No.: 10/556,119

(22) PCT Filed: May 11, 2004
(86) PCT No.: PCT/IB04/50635

§ 371 Date: Nov. 8, 2005

(30) Foreign Application Priority Data
May 12, 2003 (EP) 03076441.9

(51) Int. Cl. G11B 5/09

(52) U.S. Cl. 369/59.1

(57) ABSTRACT

When processing a two dimensional data area it is known to be advantageous to divide the two dimensional are into stripes and process each stripe using a stripe-wise detector. When processing a data area delimited by more than one guard band it is advantageous to start a subset of bit detectors from each guard band in order to propagate the improved reliability of the side information obtained from the guard band through the subset of detectors. Because the subsets can start processing at the same time the overall detection delay is reduced.

### FIELD OF THE INVENTION

The invention relates to a trellis-based symbol detection method for detecting symbols of a channel data stream recorded on a record carrier. The invention applies to digital recording systems, such as magnetic recording and optical recording systems. It is particularly advantageous for two-dimensional optical recording, which is one of the potential technologies for the next generations of optical recording.

### BACKGROUND ART

Current state-of-the-art optical disc systems are based on one-dimensional (ID) Optical Recording. A single laser beam is directed at a single track of information, which forms a continuous spiral on the disc, spiraling outwards to the outer edge of the disc. The single spiral contains a single (or one dimensional, 1D) track of bits. The single track consists of sequences of very small pit-marks or pits and the spaces between them, which are called land-marks or lands. The laser light is diffracted at the pit structures of the track. The reflected light is detected on a photo-detector Integrated Circuit (IC), and a single high-frequency signal is generated, which is used as the waveform from which bit-decisions are derived. A new route for the 4th generation of optical recording technology that will succeed “Blue Ray Disc” also called “DVR” already succeeding DVD (Digital Video Disc) technology is based on two-dimensional (2D) binary optical recording. 2D recording means that e.g. 10 tracks are recorded in parallel on the disc without guard space in between. Then, the 10 tracks together form one big spiral. The format of a disc for 2D optical recording (called in short a “2D disc”) is based on that broad spiral, in which the information is recorded in the form of 2D features. The information is written as a honeycomb structure and is encoded with a 2D channel code, which facilitates bit detection. The disc shall be read out with an array of e.g. 10 (or more) optical spots, which are sampled in time, in order to obtain a two dimensional array of samples in the player. Parallel read out is realized using a single laser beam, which passes through a grating, which produces the array of laser spots. The array of spots scans the full width of the broad spiral. The light from each laser spot is reflected by the 2D pattern on the disc, and is detected on a photo-detector IC, which generates a number of high frequency signal waveforms. The set of signal waveforms is used as the input of the 2D signal processing. The motivation behind 2D recording is that much less disc space is wasted as guard space, so that the recording capacity of the disc can be increased. Although 2D recording is first studied for optical recording, similarly, magnetic recording can also be made two-dimensional. One of the new aspects of such recording techniques is that they require two dimensional signal processing. In particular, one optical spot must be considered as a device which takes a plane of “pits”/“lands” (or “marks” and “non-marks”) as input and produces a corresponding output. The optical spot transfer function has the characteristics of a 2D low pass filter, whose shape can be approximated by a cone. Apart from its linear transfer characteristics, the 2D optical channel also has non-linear contributions. The radius of the cone corresponds to the cutoff frequency, determined by the numerical aperture of the lens, and the wavelength of the light. This filtering characteristic causes 2D Inter Symbol Interference (ISI) in the player. It is the task of a bit-detector to annihilate (most of) this ISI (which can be both linear and non-linear). An optimal way to implement a bit-detector is to use a Viterbi algorithm. A Viterbi bit detector does not amplify the noise. If soft decision output, i.e. reliability information about the bits, is required, a dual-Viterbi i.e. (Max-)(Log-)MAP, or MAP, or SOVA (Soft Output Viterbi) algorithm can be used. One of the difficulties of designing a bit-detector for the 2D case, is that a straightforward Viterbi bit-detector would need as its “state”, one or more columns of “old” track bits because of the memory of the ISI. If e.g. 10 tracks are recorded in parallel in the 2D broad spiral, and e.g. two old bits per track is needed for a proper description of the state because of the tangential extent (along-the-tracks) of the 2D impulse response, this results in a state of 2×10=20 bits. Thus, the number of states in the Viterbi (or MAP, (Max-)(Log-)MAP, MAP, SOVA, etc.) algorithm becomes 2²⁰, which is completely impractical. This requires a different approach, which may be slightly sub optimal, but has a significantly reduced complexity.

EP 02 292937.6 provides a solution by dividing the broad spiral into several stripes each comprising a subset of rows, thus reducing the complexity of the detector since each detector only needs to cover a subset of rows of the broad spiral, substantially reducing the complexity of the detectors.

In order to perform the detection across all the rows of the broad spiral a detector processes a stripe and provides, together with the output symbols side information that is to be used by the detector when processing the adjacent stripe, thus linking the detection results to cover the whole of the broad spiral with a single detector

This implementation has the disadvantage that it requires symbol detectors of high complexity in order to achieve a desired low error floor.

It is an objective of the invention to overcome this disadvantage by providing a detection method with reduced complexity symbol detectors that still achieves the desired low error floor.

In order to achieve this objective the invention is characterized in that the iterative algorithm is applied using a first subset of symbol detectors starting from a guard band delimiting the N-dimensional channel tube and comprising data that can be retrieved with high reliability and a second subset of symbol detectors starting from a further guard band delimiting the N-dimensional channel tube and comprising further data that can be retrieved with high reliability.

One iteration of the stripe-wise bit-detector may consist out of a successive processing of stripes starting from the guard band on top of the broad spiral towards the guard band at the bottom of the broad spiral. Instead, one can start with stripes from both guard bands and successively process a number of stripes proceeding from both sides towards the middle of the broad spiral. The result is that the detectors for the successive stripes are arranged in a V-shape. The first subset of Viterbi-detectors are cascaded one after the other with mutual delay to allow for back-tracking of the respective detectors, and the cascade starts from the top guard-band towards the center of the broad spiral; each of these Viterbi-detectors has as output the bit-decisions for the top bit-row. Each of these Viterbi-detectors also uses the signal waveform samples at the bit-row above the stripe as additional extra row in the branch metrics. In analogy, the second subset of Viterbi-detectors are cascaded one after the other, also with mutual delay for back-tracking purposes, starting from the bottom guard-band towards the center of the broad spiral. Each of these detectors has as output the bit-decisions for the bottom bit-row. Each of these Viterbi-detectors also uses the signal waveform samples at the bit-row below the stripe as additional extra row in the branch metrics. These two subsets of cascaded Viterbi-detectors have a mutual mirror-type of relationship. Finally, the two cascades of stripes are terminated in the middle of the broad spiral with a last stripe, which is the only stripe that has as output its two bit-rows, and which has extra exterior bit-rows on both sides of the stripe of which the signal waveforms are included in the computation of the branch metrics of that stripe.

With the V-shaped stripe-wise bit-detector, the propagation direction of “bit-reliability” is from the known bits of the guard band towards the bit-row in the middle of the broad spiral, which are thus the largest distance from the guard bands. The “known” information is propagated from both sides towards the middle.

An embodiment of the method is characterized in that the data that can be retrieved with high reliability is predefined data.

The guard band can comprise predefined data. Because the predefined data is known a priori to the detector no errors are made detecting this data and the data can thus be reliably retrieved increasing the reliability of the side information propagating from detector to detector.

An embodiment of the method is characterized in that the data that can be retrieved with high reliability is protected using redundant coding.

The guard band can comprise data that is protected using redundant coding that provides more protection against errors than the data outside the guard band. Because the data can be detected with a higher reliability less errors are made detecting this data and the data can thus be reliably retrieved, increasing the reliability of the side information, derived from the detection of the data in the guard band, propagating from detector to detector.

This idea can be generalized in the following way: the stripes can be cascaded as two sets forming a V-shaped configuration between any pair of two bit-rows in the 2D area that have a significantly higher bit-reliability, so that they can serve as anchor points from which successive stripes can propagate in a two-sided way towards each other in the middle area between the two rows with high bit-reliability. In the particular case (treated above) of a broad spiral with two guard bands with bits that are known to the detector, the bit-reliability of the two anchor bit-rows is 100%. Another example is the case of a 2D format with an extra bit-row in the middle of the spiral, that is encoded such that it has a higher bit-reliability than the other rows; then, two V-shaped progressions of stripes can be devised, one operating between the center bit-row and the upper guard band, the other operating between the same center bit-row and the lower guard band (see FIG. 11). For instance, the center bit-row may be channel encoded with a 1D runlength limited (RLL) channel code that enables robust transmission over the channel: for instance, a d=1 RLL channel code removes some of the clusters (those with a “1” central bit and all six “0”'s as neighbour bits, and vice versa) in the overlap area of the signal patterns, hereby increasing the robustness of bit-detection on the one hand, but reducing the storage capacity for that row on the other hand because of the constrained channel coding.

During back-tracking of a Viterbi-processor for a given stripe, it is an option to output all bit-rows of the stripe so that a bit-array with the most recent bit-estimates are stored. The purpose of this measure is to achieve a more uniform architecture for the Viterbi-processors in the top-half, bottom-half and central area of a V-shaped bit-detection scheme.

An embodiment of the invention is characterized in that the first stripe comprises a row comprising predefined data

In this embodiment the side information is derived from the directly adjacent stripe because the side information derived from the directly adjacent stripe comprising predefined data is the most pertinent side information for the bit detection of the current stripe. This is the initial step that introduces the increased reliability of the side information, derived from the reliability of the predefined data, to the first bit detection which will, after the introduction, propagate through the remaining stripes.

An embodiment of the invention is characterized in that the first stripe comprises data which is highly protected using redundant coding.

Instead of using predefined data, i.e. data which is known before hand to be present, the side information can also be derived from data that is highly protected with a redundant code such that most or all errors can be corrected before the side information is derived from the data. This results in a more reliable bit detection of the current stripe because the side information is more reliable.

Another inherent advantage is that the reliability of the side information derived from data which is highly protected using redundant coding propagates through the successive bit detectors. Because the side information obtained from the highly protected data enhances the accuracy of the bit detection of the current stripe, the reliability of the side information derived from the current stripe and provided to the next adjacent stripe will also increase, resulting in turn in a more accurate and reliable bit detection of the next stripe, which in turn will result in more reliable side information for the stripe next to the next stripe etcetera. Since each bit detection results in a more accurate output symbols compared to the situation where no highly protected data is used, less iterations for each stripe are required to obtain a target bit error rate. This consequently reduces the time required to obtain the desired bit error rate for the broad spiral as a whole, and thus the overall processing time is reduced.

An embodiment of the invention is characterized in that the predefined data is a guard band data

A guard band delimiting the broad spiral is well suited as a starting point because in its function as guard band it comprises predefined data already for other reasons not relating to bit detection. This predefined data is in the present invention used to, in addition to the other uses of the predefined data in the guard band, increase the reliability of the stripe wise bit detection of the broad spiral and to effectively obtain a decrease of the time needed to perform the bit detection of the broad spiral.

An embodiment of the method is characterized in that the first subset of detectors operates at least partially at the same time as the second subset of detectors.

By using multiple guard bands the methods outlined in the previous embodiments can be used to start multiple bit detectors in parallel. Near each guard band a bit detector starts, using the side information derived from that guard band, a cascade of bit detectors where each bit detector in the cascade closely trails the previous detector in the cascade. When using the 2 dimensional broad spiral as an example there would be for instance 2 guard bands, a first guards band delimiting the broad spiral at the top and a second guard band delimiting the broad spiral at the bottom. A first cascade of bit detectors starts at the first guard band and propagating the increased reliability down in the cascade towards the second guard band. A second cascade of bit detectors starts at the second guard band and propagating the increased reliability up in the cascade towards the first guard band.

The two cascades of bit detectors would meet somewhere on the broad spiral, for instance at the middle of the broad spiral, each having processed the upper portion of stripes of the broad spiral, respectively the lower portion of stripes of the broad spiral.

In a graphic sense the cascades of bit detectors form a V shape constellation of bit detectors where the open end of the V shape points in the direction of processing of the broad spiral.

Where the two cascades meet one can choose to process a final stripe using either the side information from the cascade having processed the lower portion of stripes, the side information from the cascade having processed the upper portion of stripes, or both side informations.

In addition it is possible to have a bit detector from both cascades process the final stripe.

By working both the upper and lower portion of the broad spiral in parallel the processing time is greatly reduced.

The invention will now be described based on figures.

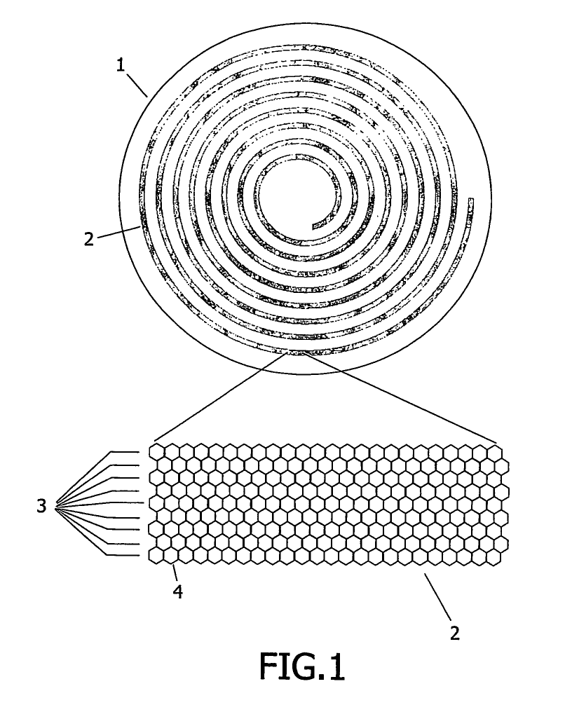

FIG. 1 shows a record carrier comprising a broad spiral.

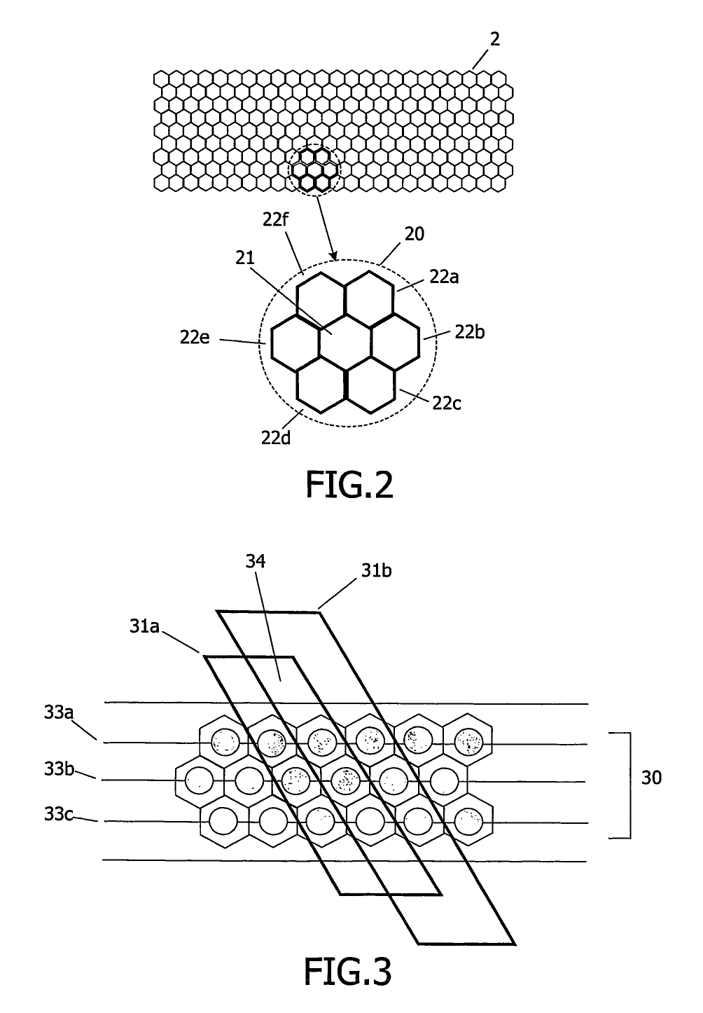

FIG. 2 shows the contributions of leaked away signal energy.

FIG. 3 shows the states and branches for a viterbi detector in a three row stripe.

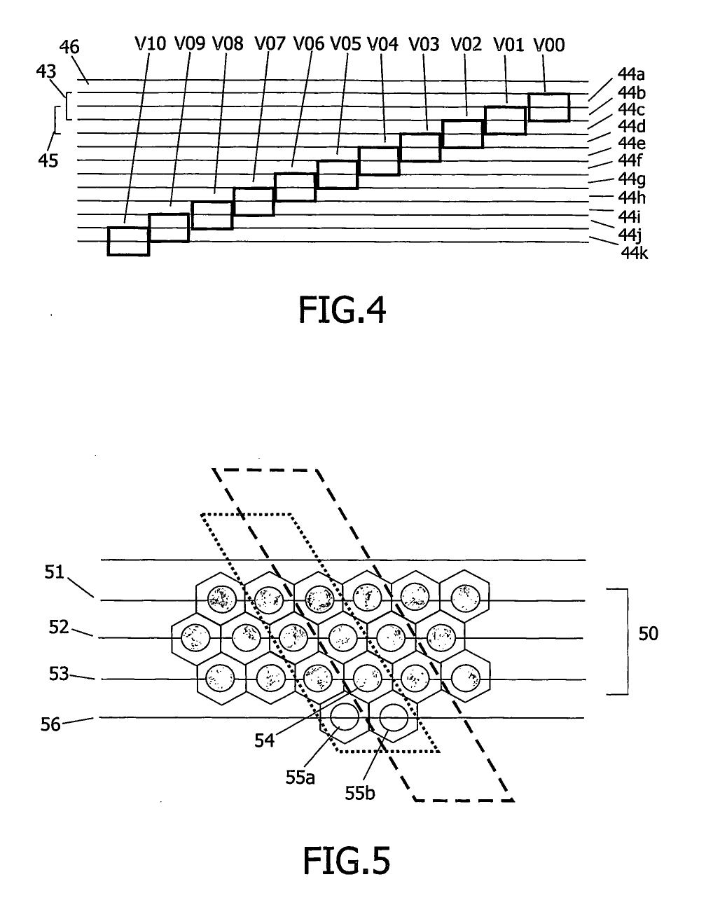

FIG. 4 shows multiple detectors processing a broad spiral.

FIG. 5 shows the reduction of weights in a stripe wise bit detector

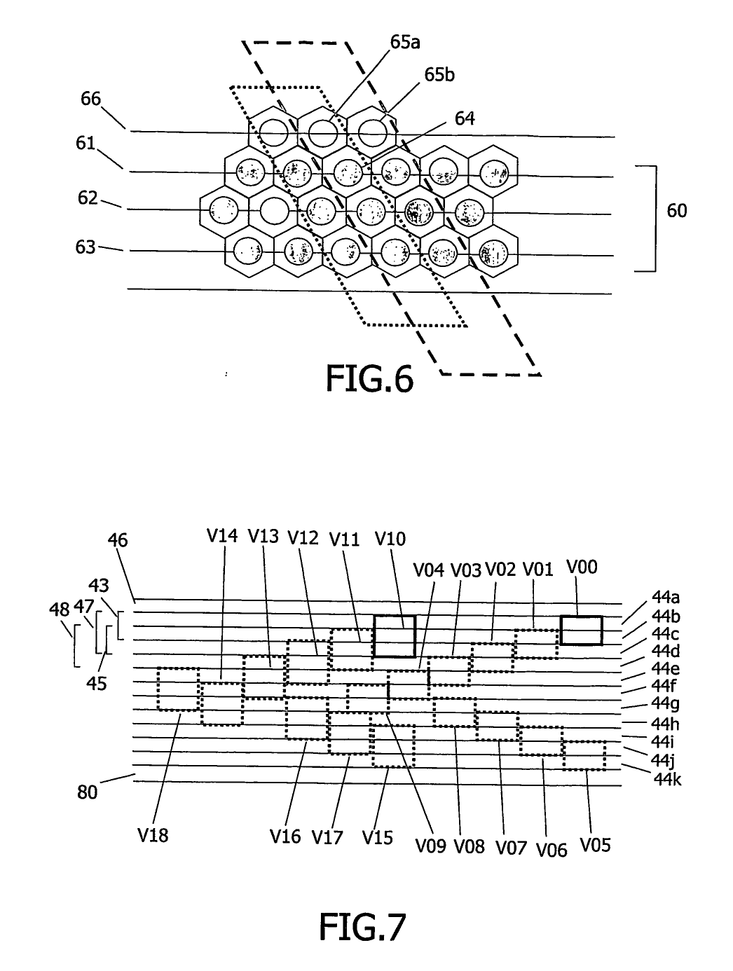

FIG. 6 shows the extension of the computation of branch metrics with samples of the signal waveform at bits in the bit row above the stripe.

FIG. 7 shows a stripe wise bit detection along a broad spiral where the stripe is oriented in a different direction.

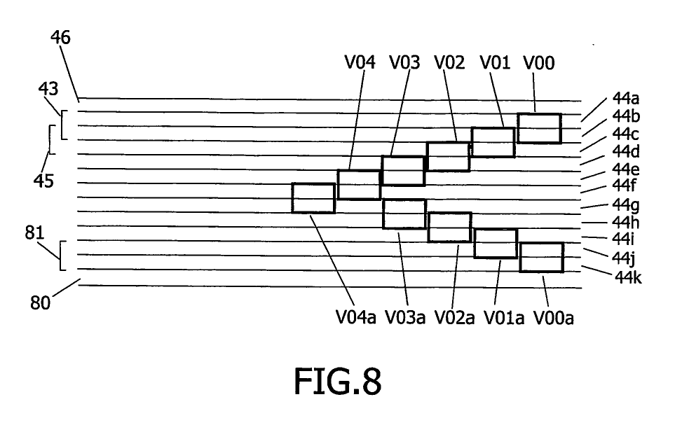

FIG. 8 shows the result of performing the second iteration with a detector with a higher complexity than the detector performing the first iteration.

FIG. 1 shows a record carrier comprising a broad spiral.

The invention concerns with an extension of the concept of branch metrics to be used for the processing along a Viterbi-trellis of a stripe, involving (i) signal waveform samples of bits outside of the stripe, thus not belonging to the states of the Viterbi processor for the stripe considered and (ii) the introduction of reduced weights smaller than the maximum weight (set equal to 1) for the separate terms in the branch metric that are related to the different bit-rows within the stripe, and (iii) the introduction of cluster-driven weights due to signal-dependent noise characteristics.

The context of this invention is the design of a bit-detection algorithm for information written in a 2D way on a disc 1 or a card. For instance, for a disc 1, a broad spiral 2 consists of a number of bit-rows 3 that are perfectly aligned one with respect to the other in the radial direction, that is, in the direction orthogonal to the spiral 2 direction. The bits 4 are stacked on a regular quasi close-packed two-dimensional lattice. Possible candidates for a 2D lattice are: the hexagonal lattice, the square lattice, and the staggered rectangular lattice. This description is based on the hexagonal lattice because it enables the highest recording density.

For ambitious recording densities the traditional “eye” is closed. In such a regime, the application of a straightforward threshold detection will lead to an unacceptably high bit error rate (10⁻² to 10⁻¹, dependent on the storage density), prior to ECC decoding. Typically, the symbol or byte error-rate (BER) for random errors in the case of a byte-oriented ECC (like the picket-ECC as used in the Blu-Ray Disc Format, BD) must be not larger than typically 2 10⁻³; for an uncoded channel bit stream, this corresponds to an upper bound on the allowable channel-bit error rate (bER) of 2.5 10⁻⁴.

On the other hand, full-fledged PRML type of bit-detectors would require a trellis which is designed for the complete width of the broad spiral 2, with the drawback of an enormous state-complexity. For instance, if the horizontal span of the tangential impulse response along the direction of the broad spiral 2 is denoted by M, and if the broad spiral consists of N_{row} bit-rows, then the number of states for the full-fledged “all-row” Viterbi bit-detector becomes 2ˆ((M-1)N_{row}) (where ˆ denotes exponentiation). Each of these states has also 2ˆ(N_{row}) predecessor states, thus in total the number of branches or transitions between states equals 2ˆ(MN_{row}). The latter number (number of branches in the Viterbi trellis) is a good measure for the hardware complexity of a 2D bit-detector.

Ways to largely circumvent this exponentially growing state-complexity are the breakdown of the broad spiral 2 into multiple stripes. The state-complexity can be reduced by a stripe-based PRML-detector, and iterating from one stripe towards the next. Stripes are defined as a set of contiguous “horizontal” bit-rows in the broad spiral. Such a bit-detector is shortly called a stripe-wise detector. The recursion between overlapping stripes, the large number of states, i.e. 16 for a stripe of 2 rows, and 64 states for a stripe of 3 rows, and the considerable number of branches, i.e. 4 for a stripe of 2 rows, and 8 for s stripe of 3 rows, and the recursive character of each individual PRML detector make that the hardware complexity of such a detector can still be quite considerable.

It is an object of the invention to provide a further reduction of the complexity of the stripe-wise bit-detector and meanwhile not sacrificing on its performance.

FIG. 2 shows the contributions of leaked away signal energy.

The signal-levels for 2D recording on hexagonal lattices are identified by a plot of amplitude values for the complete set of all hexagonal clusters possible. An hexagonal cluster 20 consists of a central bit 21 at the central lattice site, and of 6 nearest neighbour bits 22a, 22b, 22c, 22d, 22e, 22f at the neighbouring lattice sites. The channel impulse response is assumed to be isotropic, that is, the channel impulse response is assumed to be circularly symmetric. This implies that, in order to characterize a 7-bit hexagonal cluster 20, it only matters to identify the central bit 21, and the number of “1”-bits (or “0”-bits) among the nearest-neighbour bits 22a, 22b, 22c, 22d, 22e, 22f (0, 1, . . . , 6 out of the 6 neighbours can be a “1”-bit). A “0”-bit is a land-bit in this description.

Note that the isotropic assumption is purely for the purpose of concise presentation. In a practical drive with a tilted disc, the 2D impulse response can have asymmetry. There are two solutions for the latter issue: (i) to apply a 2D equalizing filter restoring a rotationally symmmetric impulse response, and (ii) application of a larger set of reference levels to be used in the branch metric computation, wherein each rotational variant of a given cluster has its own reference level; for this general case, for a 7-bit cluster, consisting of a central bit 21 and its six neighbours 22a, 22b, 22c, 22d, 22e, 22f, we will have 2ˆ7=128 reference levels, instead of the 14 reference levels in case of the isotropic assumption of above.

The channel bits that are written on the disc are of the land type (bit “0”) or of the pit-type (bit “1”). With each bit a physical hexagonal bit-cell 21, 22a, 22b, 22c, 22d, 22e, 22f is associated, centered around the lattice position of the bit on the 2D hexagonal lattice. The bit-cell for a land-bit is a uniformly flat area at land-level; a pit-bit is realized via mastering of a (circular) pit-hole centered in the hexagonal bit-cell. The size of the pit-hole is comparable with or smaller than half the size of the bit-cell. This requirement eliminates the “signal folding” issue, which would arise for a pit-hole that covers the full area of the hexagonal bit-cell 21, 22a, 22b, 22c, 22d, 22e, 22f: in such case, both for a cluster of all zeroes (all-land) as well as for a cluster of all ones (all-pit), a perfect mirror results, with identical signal levels for both cases. This ambiguity in signal levels must be avoided since it hampers reliable bit-detection.

For high-density 2D optical storage, the 2D impulse response of the linearized channel can be approximated to a reasonable level of accuracy by a central tap with tap-value c₀ equal to 2, and with 6 nearest-neighbour taps with tap-value c₁ equal to 1. The total energy of this 7-tap response equals 10, with an energy of 6 along the tangential direction (central tap and two neighbour taps), and an energy of 2 along each of the neighbouring bit-rows (each with two neighbour taps).

From these energy considerations, one of the main advantages of 2D modulation can be argued to be the aspect of “joint 2D bit-detection”, where all the energy associated with each single bit is used for bit-detection. This in contrast to 1D detection with standard cross-talk cancellation, where only the energy “along-track” is being used, thus yielding a 40% loss of energy per bit.

A similar argumentation holds when we consider bit detection at the edges of a 2D stripe (for which we want to output the top bit-row). Of the order of 20% of the signal-energy of the bits in the top-row has leaked away in the samples of the signal waveform of the two samples in the bit-row just above the stripe: these two samples are located at nearest neighbour sites of the bit in the top row of the current stripe. The other 20% leaking away from the top bit-row is leaking away in the bit-row below the top bit-row in the stripe: this energy is used because the stripe (of at least two bit-rows wide) comprises also the bit-row below the top bit-row of the stripe. Consequently, not using the leaked away information, that has been leaking away in the “upward” direction (when the top bit-row is the output of the considered stripe), would lead to a loss in bit-detection performance at the top row of the stripe.

The solution to the above drawback is to include the HF-samples in the bit-row above the stripe in the computation of the figure-of-merit Note that only the samples of the signal waveform of that row do matter here, and that the bits in that row are not varied since they do not belong to the set of bits that are varied along the trellis and states of the Viterbi-detector for the stripe considered. Denoting the row-index of the bit-row above the stripe by l−1, the branch metric is denoted by (with the running index j now starting from −1”):

$${β}_{mn} = {\sum }_{j = - 1}^{2} {w}_{j} {\vert H {F}_{k , l + j} - RL ( {Σ}_{m} -> {Σ}_{n} , j , l ) \vert}^{2}$$

This extension of the computation of the branch metrics with inclusion of the row of signal samples in the bit-row above the stripe is schematically drawn in FIG. 6. Note that in the computation of the reference levels, all the required bits within the stripe are set by the two states that constitute a given branch, and all the required bits outside the stripe are determined by the previous stripe in the current iteration of the stripe-wise bit-detector, or by the previous iteration of the stripe-wise bit-detector.

For the sake of completeness, note that the above description applies to a top-to-bottom processing of the stripes, wherein the output of each stripe is its top bit-row, and the extra bit-row that is accounted for in the branch metrics, is the row just above the stripe, with index j=−1. However, for the opposite processing order, from bottom-to-top, the output of each stripe is its bottom bit-row, and the extra bit-row that is accounted for in the branch metrics, is the row just below the stripe, with index j=3 (for a 3-row stripe).

FIG. 3 shows the states and branches for a viterbi detector in a three row stripe.

First the basic structure of the trellis as shown in FIG. 3 is explained, addressing the practical case of a 3-row stripe 30. The tangential span of the 2D impulse response is assumed to be 3 bits wide, a situation that meets the practical conditions for the high-density recording on a hexagonal grid. A state 31a, 31b is specified by two columns extending over the full radial width of 3 rows 33a, 33b, 33c of the stripe 30. There are thus in this example exactly 2ˆ6=64 states. The pace of the Viterbi bit-detector goes with the frequency of emission of a 3-bit column 34. Emission of a 3-bit column 34 corresponds with a state transition from a so-called departure state Σₘ 31a to a so-called arrival state Σₙ 31b. For each arrival state 31b, there are exactly 8 possible departure states 31a and thus 8 possible transitions. A transition between two states 31a, 31b is called a branch in the standard Viterbi/PRML terminology. For each transition, there are thus two states and thus a total of 9 bits that are completely specified by these two states. For each branch, there are a set of reference values which yield the ideal values of the signal waveform at the branch bits: these ideal values would apply if the actual 2D bit-stream along the stripe 30 would lead to the considered transition in the noise-free case. With each transition a branch metric can be associated which gives a kind of “goodness-of-fit” or “figure-of-merit” for the considered branch or transition based on the differences that occur between the observed “noisy” signal waveform samples, denoted by HF, and the corresponding reference levels which are denoted by RL. It should be noted that the noise on the observed samples of the waveform can be due to electronic noise, laser noise, media noise, shot noise, residual ISI beyond the considered span of the 2D impulse response etc. It is common practise to consider as the branch bits, at which these differences for the figure-of-merit are to be measured, the bits that are common to both states 31a, 31b that constitute the branch: in FIG. 3, this would be the 3 bits of the column at the intersection of the two states 31a, 31b. Thus, if k denotes the tangential index at the position of the intersection column, and l denotes the top bit-row 33a of the stripe 30, the branch metric βₘₙ between the state Σₘ 31a and the state Σₙ 31b is given by:

$${β}_{mn} = {\sum }_{j = - 1}^{2} {\vert H {F}_{k , l + j} - RL ( {Σ}_{m} -> {Σ}_{n} , j , l ) \vert}^{2}$$

The above formula is based on the assumption of a quadratic error measure for the figure-of-merit (L₂—norm), which is optimum for the assumption of additive white gaussian noise (AWGN). It is also possible to use or error measures, like the absolute value of the difference (known as L₁—norm). For the determination of a reference level for a bit at a given location k, l+j on the 2D lattice, the values of the six surrounding bits 22a, 22b, 22c, 22d, 22e, 22f around the location k, l+j are needed together with the value of the central bit 21: these 7 bits 21, 22a, 22b, 22c, 22d, 22e, 22f uniquely specify the reference level to be used for the considered state transition or branch at the considered bit-location 21.

FIG. 4 shows multiple detectors processing a broad spiral.

The standard way of operation of the stripe-wise bit-detector will now be described. A stripe 43, 45 consists of a limited number of bit-rows 44a, 44b, 44c. For FIG. 4, the practical case of a stripe comprising two bit-rows in a stripe is shown. Note that in FIG. 4, a bit-row is bounded by two horizontal lines at its edges. The number of stripes is equal to the number of bit-rows in the case of two bit rows per stripe. A set of Viterbi bit-detectors V00, V01, V02, V03, V04, V05, V06, V07, V08, V09, V10 is devised, one for each stripe. Although the Viterbi bit detectors are shown as separate detectors, a single detector can be used to perform the work of the set of detectors V00, V01, V02, V03, V04, V05, V06, V07, V08, V09, V10. The bits outside of a given stripe that are needed for the computation of the branch metrics, are taken from the output of a neighboring stripe, or are assumed to be unknown. In a first iteration the unknown bits may be set to zero. The first top-stripe 43, containing as its top row, the bit-row 44a closest to the guard band 46 is processed by bit detector V00 without any delay at its input; it uses the bits of the guard band 46 as known bits. The output of the bit detector V00 processing the first stripe are the bit-decisions in the first bit-row 44a The second stripe 45 contains the second row 44b and the third bit-row 44c, and is processed by the second bit detector V01 with a delay that matches the back-tracking depth of the Viterbi-detector of the first stripe 43, so that the detected bits from the output of the bit detector V00 processing the first stripe 43 can be used for the branch metrics of the second stripe 45. As stated before the function of the second bit detector V01 can also be performed by the same detector V00 that performed the detection of the first stripe 43. This would result in a longer delay in the detection because the first detector can only start processing the second stripe 45 after finishing a section of the first stripe 43. This procedure is continued for all stripes in the broad spiral 2. The full procedure from top to bottom of the broad spiral 2 is considered to be one iteration of the stripe-wise detector. Subsequently, this procedure can be repeated starting again from the guard band 46 at the top: for the bits in the bit-row just below the bottom of a given stripe, the bit-decisions from the previous iteration can be used. This schematically indicated in FIG. 4 by the second set of detectors V10, V11, V12, V13, V14, V15, V16, V17, V18, V19, V20 trailing behind the first set of detectors V00, V01, V02, V03, V04, V05, V06, V07, V08, V09, V10. The complexity of the detector in the second set is higher than the complexity of the detector in the first set processing the same stripe. Since in the first iteration the detection is performed on relatively low reliability data the result of the detection will be an improved reliability of the data. Using a detector with a higher complexity would not result in a substantial improvement compared to the situation where a detector with lower complexity is used. In the second iteration the data on which the detection is performed has improved as a result of the first iteration and a higher complexity detector will result in better detection results. Since it is possible that the complexity of the detectors within one iteration varies, for instance by using a higher complexity detector for the first stripe 43 where side information with a high reliability can be derived from the guard band 46, the increase in complexity of the detector between the iterations is to be taken between detectors that process the same stripe.

It is also clear from FIG. 4 that the reliability of the side information decreases the further away the detector is from the guard band. The first detector V00 closest to the guard band 46 gets side information which is highly reliable because the side information is either predefined information where no detection errors can be made because the desired outcome of the detection is known or error protected information where the information can be retrieved with high reliability due to the error correction coding. The second detector V01 receives less reliable side information from the first detector V00. The complexity of the second detector V01 can thus be lower than the complexity of the first detector V00. Because each detector introduces errors in the side information it provides to the next detector, a detector adjacent in the same iteration or a detector in the next iteration, the complexity of the subsequent detector can be reduced. When all detectors of each iteration are chosen to have the same complexity, the complexity of the detectors varies from iteration to iteration.

In a top-to-bottom processing of successive stripes, the last stripe processor V10 is assumed to output its top bit-row. Another implementation is possible here: the bottom stripe bit detector V10 could be omitted, and alter the 2-row stripe processor V09 to process the three bottom bit rows 44i, 44j, 44k, thus processing the two bottom rows 44j, 44k of the broad spiral 2 such that it outputs both rows simultaneously.

FIG. 5 shows the reduction of weights in a stripe wise bit detector

In FIG. 4 it has been shown that a stripe is shifted from the top of the broad spiral in the downward direction towards the bottom of the spiral. The stripe shifts row per row downwards. Each stripe has as its output the bit-decisions of the top bit-row of the stripe which is the most reliable. That output bit-row is also used as side-information for the bit detection of the next stripe which is the stripe which is shifted one bit-row downwards. The bit-row just across the bottom of the stripe on the other hand still needs to be determined in the current iteration, so only the initialisation bit-values can be used in the first iteration of the stripe-wise bit-detector, or in any subsequent iteration. The bit-decisions resulting from the previous iteration of the stripe-wise bit-detector can be used for that bit row. Therefore, in FIG. 5 the bit-decisions of the three row stripe wise bit detector V02 in the upper bit-row 51 are more reliable than the bit-decisions in the bottom bit-row 53. This is the reason why the output of one stripe is its top bit-row. Also, for the computation of the required reference levels in the bottom bit-row, we need as explained in FIG. 2, the six nearest neighbour bits of the branch bit 54 in the bottom bit-row; two neighbour bits 55a, 55b of these nearest neighbour bits are located in the bit-row 56 just below the stripe considered, and only preliminary bit-decisions, for instance from the previous iteration, are available for these neighbour bits 55a, 55b. Consequently, in case of bit-errors in these two neighbour bits 55a, 55b in the bit-row 56 below the current stripe 50, these errors will affect the selected branches in the surviving path along the Viterbi trellis: actually, the bit-errors in these two neighbour bits 55a, 55b may be compensated by selecting the wrong bits in the states along the stripe, so that the error measure at the bottom branch bit can be kept low enough. Unfortunately, this balancing will propagate errors towards the top bit-row 51 of the stripe 50, which should be prohibited.

In order to prevent the propagation of errors towards the top bit row 51 of the stripe 50 the relative weight for the bottom branch bit in the figure-of-merit is reduced from the full 100%, i.e. a weighting of 1, to a lower fraction. With wᵢ denoting the weight of the branch bit in the i-th row of the stripe, the branch metric becomes:

$${β}_{mn} = {\sum }_{j = 0}^{2} {w}_{j} {\vert H {F}_{k , l + j} - RL ( {Σ}_{m} -> {Σ}_{n} , j , l ) \vert}^{2}$$

By choosing the weight of the bottom row 53 in the stripe 50 to be much lower than 1, the negative influence of the unknown or only preliminary known bits 55a, 55b in the bit-row 56 just below the current stripe 50 is largely reduced. The weights of the respective contributions of the signal waveforms to the branch metrics can also be varied from one iteration to the next because the bit-decisions at the surrounding bits become gradually more and more reliable.

For the sake of completeness, note that the above description applies to a top-to-bottom processing of the stripes, wherein the output of each stripe is its top bit-row, and the weight of the bottom bit-row is reduced. However, for the opposite processing order, from bottom-to-top, the output of each stripe is its bottom bit-row, and the weight of the top bit-row is reduced.

In detection theory, it is a well-known known fact that in an optimal Viterbi detector, the branch metrics are (negative) log-likelihoods of the channel input bits given the observed channel output values. Already in Section 3.1 it was argued that the branch metric formula

$${β}_{mn} = {\sum }_{j = 0}^{2} {\vert H {F}_{k , l + j} - RL ( {Σ}_{m} -> {Σ}_{n} , j , l ) \vert}^{2}$$

derives its validity from the assumption that the noise is Additive, Gaussian and White. The squares inside the sum above stem from the logarithm of the Gaussian probability density function of the noise gₘₙ which also contains a square,

$$- log ( Pr \{ {g}_{mn} = g \} ) = \frac{1}{2} log ( 2 π N ) + \frac{{g}^{2}}{2 N}$$

The whiteness assumption of the noise implies that different noise components are statistically independent, so that their probability density functions can be multiplied. Therefore, their log-likelihood functions can be added, as in the βₘₙ formula

The problem we want to consider here, is that e.g. for an optical recording the variance of the noise N may depend on the central input bit of a given channel output HF_{k,l+j} and its cluster of nearest neighbour inputs. For example, in case laser noise is dominant, larger channel outputs HF_{k,l+J} carry more (multiplicative) laser noise (which is usually referred to as ‘RIN’, “relative intensity noise”). This leads to the question what value of the noise N to use in the branch metric formula for βₘₙ?

The solution to this problem is very simple. Based on a table of the cluster-dependent noise variances, we make a table for the noise variance N(Σₘ→Σₙ,j) as a function of the state transition (Σₘ→Σₙ) and the row index j, and we divide by the adjusted value of N in the branch metric formula,

$${β}_{mn} = {\sum }_{j = 0}^{2} {w}_{j} \frac{{\vert H {F}_{k , l + j} - RL ( {Σ}_{m} -> {Σ}_{n} , j , l ) \vert}^{2}}{N ( {Σ}_{m} -> {Σ}_{n} , j , l )}$$

When the noise is really dependent on the cluster and on the central input bit of a given channel output, taking account of this as in the branch metric formula above makes the branch metrics more closely equal to the log-likelihood functions as stated in the introduction of this subsection. This in general results in an improvement of the resulting bit error rate at the bit-detector output.

FIG. 6 shows the extension of the computation of branch metrics with samples of the signal waveform at bits in the bit row above the stripe.

In FIG. 4 it has been shown that a stripe is shifted from the top of the broad spiral in the downward direction towards the bottom of the spiral. The stripe wise processing shifts row per row downwards. Each stripe wise detector has as its output the bit-decisions derived from the top bit-row of the stripe which is the most reliable. That output bit-row 66 of the previous stripe is also used as side-information for the bit detection of the next stripe 60 which is the stripe which is shifted one bit-row downwards. As shown in FIG. 6 the stripe 60 comprises three bit rows 61, 62, 63. In FIG. 5 it was explained that the weighting of the bottom bit row 63 is reduced to prevent errors caused by the higher uncertainty associated with the bits in the lower bit row 63 from propagating upward.

The output bit-row 66 as produced by the bit detection of the previous stripe has a higher reliability and the bits 65a, 65b of this bit row 66 can be used as side information for the processing of the next stripe 60. Especially when the output bit row 66 as produced by the bit detection of the previous stripe is derived from a guard band. The guard band has very well encoded information or even predefined data resulting in a 100% reliability of the side information used in the bit detection of the next stripe 60.

FIG. 7 shows two iterations using a detector processing stripes with different numbers of bit rows per iteration.

When the detectors are independent they can start processing a block of data as soon as the side information derived is available. The second detector V01 processes the stripe 45 adjacent to the stripe 43 processed by the first detector V00 and can start as soon as the side information is provided by the first detector V00. The third detector V10, part of the second iteration however covers more rows 44a, 44b, 44c than the first detector V00 and can therefore only start the processing of its stripe 47 once all the rows 44a, 44b, 44c in its stripe 47 have been processed during the previous iteration by the first symbol detector V00 and second symbol detector V01. The fourth symbol detector V11 processes the stripe 48 adjacent to the stripe 47 processed by the third symbol detector V10 and must consequently wait until the third symbol detector V10 provides the required side information. This way during each iteration a cascade of symbol detectors processes the broad spiral.

When limiting the number of iterations of the stripe-wise bit-detector to only two, the best performance in terms of bit-error rate (bER) is achieved when the last iteration is the most powerful one, going down as much as possible in bER: therefore, this last iteration must be subject to the smallest error floor that is achievable. That the detectors V10, V11, V12, V13, V14, V15, V16, V17, V18 performing the last iteration needs at its input the output of the detectors V00, V01. V02. V03, V04, V05, V06, V07, V08, V09 performing the previous (first) iteration, which needs to be of high enough quality. It is observed from simulation experiments that when 3-row stripes are used during the second iteration, it is satisfactory to use 2-row stripes during the first iteration. FIG. 7 shows a succession of two V-shaped iterations, the first iteration on the right-hand side comprising 2-row stripes, the second iteration on the left-hand side comprising 3-row stripes. The explanation of the different Viterbi-detectors has been given for the 2-row stripes in FIG. 4. The 3-row Viterbi-detectors V10, V11, V12, V13 are cascaded one after the other starting from the guard band 46 at the top of the broad spiral, and have as output the top bit-row of each stripe; the weight in the branch metrics of the signal waveform samples in the bottom row are reduced below 1; the branch metrics are extended to include the signal waveform samples of the bit-row just above the stripe. In analogy, the 3-row Viterbi-detectors V14, V15, V16, V17 are cascaded one after the other starting from the guard band 80 at the bottom of the broad spiral, and have as output the bottom bit-row of each stripe; the weight in the branch metrics of the signal waveform samples in the top row are reduced below 1; the branch metrics are extended to include the signal waveform samples of the bit-row just below the stripe. These two sets of cascaded Viterbi-detectors have a mutual mirror-type of relationship. Finally, the two cascades of 3-row stripe detectors V10, V11, V12, V13, V14, V15, V16, V17 are terminated in the middle of the broad spiral with a detector V18 for the last stripe, which is the only detector that has as output its three bit-rows, and which has extra exterior bit-rows on both sides of the stripe to be processed of which the signal waveforms are included in the computation of the branch metrics of that stripe. Also the weights of all signal waveforms at the branch-bits are set equal to 1, because the bit-rows at both sides of this stripe have been determined during execution of the two cascades of Viterbi-detectors V10, V11, V12, V13, V14, V15, V16, V17 in all previous stripes.

Note that the hardware complexity (which is conveniently measured in terms of the number of states times branches in a Viterbi-detector) is a factor 8× larger for a 3-stripe Viterbi than it is for a 2-stripe Viterbi. So it is advantageous to devise additional measures that may reduce the hardware complexity of the 3-stripe Viterbi, without sacrificing its performance too much.

FIG. 8 shows the stripe wise detection of a broad spiral with two guard bands.

One iteration of the stripe-wise bit-detector may consist as described above out of a successive processing of stripes 43, 45 starting from the guard band 46 on top of the broad spiral towards the guard band 80 at the bottom of the broad spiral resulting in a linear row of detectors V00, V01, V02, V03, V04, V05, V06, V07, V08, V09, V10 diagonal across the broad spiral as shown in FIG. 4. Alternatively, one can start with stripes 43, 81 from both guard bands 46, 80 and successively process a number of stripes proceeding from both sides towards the middle of the broad spiral. Successive detectors V00, V00a, V01, V01a, V02, V02a, V03, V03a, V04, V04a of the stripes are arranged in a V-shape as can be seen in FIG. 8 for the practical case of a 11 -row broad spiral and stripes 43, 45 consisting of two bit-rows. The Viterbi-detectors V00, V00a, V01, V01a, V02, V02a, V03, V03a, V04 are cascaded one after the other with mutual delay to allow for back-tracking of the respective detectors, and the cascade starts from the top guard-band 46 towards the center of the broad spiral; each of these Viterbi-detectors V00, V01, V02, V03, V04 has as output the bit-decisions for the top bit-row. Each of these Viterbi-detectors V00, V01, V02, V03, V04 also uses the signal waveform samples at the bit-row above the stripe as additional extra row in the branch metrics; the weight of the signal waveform samples in the bottom row of the stripe is reduced below the maximum value (set equal to 1). In analogy, the Viterbi-detectors V00a, V01a, V02a, V03a are cascaded one after the other (also with mutual delay for back-tracking purposes) starting from the bottom guard-band 80 towards the center of the broad spiral; each of these detectors V00a, V01a, V02a, V03a has as output the bit-decisions for the bottom bit-row. Each of these Viterbi-detectors V00a, V01a, V02a, V03a also uses the signal waveform samples at the bit-row below the stripe as additional extra row in the branch metrics; the weight of the signal waveform samples in the top row of the stripe is reduced below the maximum value (set equal to 1). These two sets of cascaded Viterbi-detectors V00, V01, V02, V03, V00a, V01a, V02a, V03a have a mutual mirror-type of relationship. Finally, the two cascades of detectors for the stripes are terminated in the middle of the broad spiral with a last detector V04a for the last stripe 44f, which is the only detector for a stripe that has as output its two bit-rows, and which has extra exterior bit-rows on both sides of the stripe (of which the signal waveforms are included in the computation of the branch metrics of that stripe); also the weights of all signal waveforms at the branch-bits are set equal to the maximum value 1 (since the bit-rows at both sides of this stripe have been determined during execution of the two cascades of Viterbi-detectors in all previous stripes).

With the V-shaped stripe-wise bit-detector V00, V01, V02, V03, V00a, V01a, V02a, V03a, V04, V04a, the propagation direction of “bit-reliability” is from the known bits of the guard band 46, 80 towards the bit-row 44f in the middle of the broad spiral, which are thus the largest distance from the guard bands: the “known” information is propagated from both sides towards the middle, which is a better approach than propagating from top to bottom of the broad spiral.

In the particular case of a broad spiral with two guard bands 46, 80 with bits that are known to the detector, the bit-reliability of the two anchor bit-rows 46, 80 is 100%. To utilize both guard bands 46, 80 the linear row of trailing detectors can be reshaped into a V shape as shown in FIG. 8. This not only utilizes the reliability of both guard bands 46, 80 by propagating the reliability through the increased reliability of the side information that each detector provides to the next, trailing detector, it also reduces the total time required to perform the detection since the first detectors V00, V00a, V01, V01a, V02, V02a, V03, V03a work in parallel providing the last detectors V04, V04a sooner with the required side information. As an alternative to the last two detectors V04, V04a a single detector that processes the middle three bit rows 44e, 44f, 44g at the same time, instead of just two rows, can be used. The overall reliability of the V shape is higher than in the case of the regular linear row of detectors because the final detector or detectors V04, V04a receive their side information through less intermediate detectors V00, V00a, V01, V01a, V02, V02a, V03, V03a.

The idea of this subsection can be generalized in the following way: the stripes can be cascaded as two sets forming a V-shaped configuration between any pair of two bit-rows in the 2D area that have a significantly higher bit-reliability, so that they can serve as anchor points from which successive stripes can propagate in a two-sided way towards each other in the middle area between the two rows with high bit-reliability. In the particular case of a broad spiral with two guard bands 46, 80 with bits that are known to the detector, the bit-reliability of the two anchor bit-rows is 100%. Another example is the case of a 2D format with an extra bit-row in the middle of the spiral, that is encoded such that it has a higher bit-reliability than the other rows; then, two V-shaped progressions of detectors processing the stripes can be devised, one operating between the center bit-row 44f and the upper guard band 46, the other operating between the same center bit-row 44f and the lower guard band 80. For instance, the center bit-row 44f may be channel encoded with a 1D runlength limited (RLL) channel code that enables robust transmission over the channel: for instance, a d=1 RLL channel code removes some of the clusters, those with a “1” central bit and all six “0”'s as neighbour bits, and vice versa, in the overlap area of the signal patterns, hereby increasing the robustness of bit-detection on the one hand, but reducing the storage capacity for that row on the other hand because of the constrained channel coding.

During back-tracking of a Viterbi-processor for a given stripe, it is an option to output all bit-rows of the stripe so that a bit-array with the most recent bit-estimates are stored. The purpose of this measure is to achieve a more uniform architecture for the Viterbi-processors in the top-half, bottom-half and central area of a V-shaped bit-detection scheme.

Prior to any Viterbi bit-detection, it is advantageous to have some preliminary bit-decisions albeit at a relatively poor bit-error rate (bER) performance. For instance, at one side of each stripe, bits that have been determined from the previous stripe or are set to zero when the stripe is located directly next to the guard band; at the other side of the stripe, bit-decisions are needed in order to be able to derive reference levels for the bits in the neighbouring bit stripe within the stripe: these bit-decisions can be derived from a previous iteration of the stripe-wise bit-detector, or from preliminary bit-decisions when the first iteration of the stripe-wise bit-detector is being executed. These preliminary decisions can just be obtained by putting all bits to zero, which is not such a clever idea.

A better approach is to apply threshold detection based on threshold levels, i.e. slicer levels, that depend on whether the row is neighbouring the guard band consisting of all zeroes or not. In the case of a bit-row 44a, 44k neighbouring the guard band 46, 80, some cluster-levels are forbidden. Consequently, the threshold level is shifted upwards. It is computed as the level between the cluster-level for a central bit equal to 0 and three 1-bits as neighbour, and the cluster-level for a central bit equal to 1 and one 1-bit as neighbour. The expected bit-error rate of this simple threshold detection is then, for this case, equal to 2/32, which is about 6%. In the case of a bit-row that is not neighbouring the guard-band, the threshold level is computed as the level between the cluster-level for a central bit equal to 0 and four 1-bits as neighbour, and the cluster-level for a central bit equal to 1 and two 1-bits as neighbour. The expected bit-error rate of this simple threshold detection is then, for this case, equal to 14/128, which is about 11%. Although these bERs are quite high, they are considerably better, especially at the bit-rows neighbouring the guard bands, than the 50% bER obtained through coin tossing. These preliminary bit-decisions obtained prior to the execution of the stripe-wise bit-detector can also be used as input for the adaptive control loops of the digital receiver (e.g. for timing recovery, gain- and offset-control, adaptive equalization etc.) Note that the above derivation of the proper slicer levels depends on the actual 2D storage density chosen and the resulting overlap of signal levels in the “Signal Patterns”.

It should be noted that the channel output is not necessarily sampled on a lattice, nor is it necessary that the channel output are sampled on a similar lattice as the lattice of channel inputs (recorded marks). E.g. the channel outputs may be sampled according to a lattice hat is shifted with respect to the lattice of channel inputs (recorded marks), e.g. sampling may take place above edges of the cells of a hexagonal lattice. Also, (signal) dependent oversampling may be applied with higher spatial sampling densities in certain directions as compared to other directions, where these directions need to be aligned with respect to the lattice of signal inputs (recorded marks).

It should be further noted that:

1. detected symbols are channel symbols.

2. detected symbols are a linear function of the channel symbols.

3. detected symbols are a linear function of the channel symbols and estimates from preceding iterations of those channel symbols.

4. detected symbols are a linear function of the channel symbols and estimates from preceding iterations of a linear function of the channel symbols.

A bit-detection method for bit-detection on a 2D array of bits, arranged on a regular 2D lattice, preferably an hexagonal bit-lattice, that is based on a stripe-wise bit-detector, in which the branch metrics, which reflect a sum of squared differences or absolute values of differences or any other applicable norm on a set of differences, said difference being computed between a received or observed sample of the signal waveform and a properly determined noise-free reference level that is typical for the branch considered, said branch metrics apply for each of the possible state-transitions along the associated trellis of the Viterbi processing, said branch metrics are generalized with respect to the following aspects:

each stripe processes a number of bit-rows simultaneously, but has only as output the bit-row at one of its boundaries. The branch metric computation is extended to include the signal waveform samples from the bits in the neighbouring bit-row just exterior to the stripe, and at the side of the output bit-row of the stripe, since the signal energy of the output bit-row has leaked away partly into the samples of said exterior bit-row. The bits in said exterior bit-row beyond the stripe, at the side of the output bit-row, are not varied according to the trellis of the Viterbi-detector, but are determined from a previous position of the stripe, when said exterior bit-row was the output bit-row of said previous position of the stripe.

the branch metrics are a sum of separate terms, one term for each branch bit considered to contribute to the branch metrics; each term may have a local weight that depends on the position of said branch metric relative to the edges of said stripe, for instance, the weights for branch bits that are far away from the output bit-row at one side of the stripe, may be set to low values;

each term in the branch metric may be weighted by a transition-dependent and cluster-dependent noise variance, said weighing combating the influence of signal-dependent noise.

A bit-detection method for bit-detection on a 2D array of bits, arranged on a regular 2D lattice, preferably an hexagonal bit-lattice, that is based on a stripe-wise bit-detector, in which the branch metrics, which reflect a sum of squared differences or absolute values of differences or any other applicable norm on a set of differences, said difference being computed between a received or observed sample of the signal waveform and a properly determined noise-free reference level that is typical for the branch considered, said branch metrics apply for each of the possible state-transitions along the associated trellis of the Viterbi processing, said branch metrics are generalized with respect to the following aspects:

each stripe processes a number of bit-rows simultaneously, but has only as output the bit-row at one of its boundaries. The branch metric computation is extended to include the signal waveform samples from the bits in the neighbouring bit-row just exterior to the stripe, and at the side of the output bit-row of the stripe, since the signal energy of the output bit-row has leaked away partly into the samples of said exterior bit-row. The bits in said exterior bit-row beyond the stripe, at the side of the output bit-row, are not varied according to the trellis of the Viterbi-detector, but are determined from a previous position of the stripe, when said exterior bit-row was the output bit-row of said previous position of the stripe.

the branch metrics are a sum of separate terms, one term for each branch bit considered to contribute to the branch metrics; each term may have a local weight that depends on the position of said branch metric relative to the edges of said stripe, for instance, the weights for branch bits that are far away from the output bit-row at one side of the stripe, may be set to low values;

each term in the branch metric may be weighted by a transition-dependent and cluster-dependent noise variance, said weighing combating the influence of signal-dependent noise where the weight in the branch metric of the bit-row that is exterior to said stripe, is put to zero.

A bit-detection method for bit-detection on a 2D array of bits, arranged on a regular 2D lattice, preferably an hexagonal bit-lattice, that is based on a stripe-wise bit-detector, in which the branch metrics, which reflect a sum of squared differences or absolute values of differences or any other applicable norm on a set of differences, said difference being computed between a received or observed sample of the signal waveform and a properly determined noise-free reference level that is typical for the branch considered, said branch metrics apply for each of the possible state-transitions along the associated trellis of the Viterbi processing, said branch metrics are generalized with respect to the following aspects:

each stripe processes a number of bit-rows simultaneously, but has only as output the bit-row at one of its boundaries. The branch metric computation is extended to include the signal waveform samples from the bits in the neighbouring bit-row just exterior to the stripe, and at the side of the output bit-row of the stripe, since the signal energy of the output bit-row has leaked away partly into the samples of said exterior bit-row. The bits in said exterior bit-row beyond the stripe, at the side of the output bit-row, are not varied according to the trellis of the Viterbi-detector, but are determined from a previous position of the stripe, when said exterior bit-row was the output bit-row of said previous position of the stripe.

the branch metrics are a sum of separate terms, one term for each branch bit considered to contribute to the branch metrics; each term may have a local weight that depends on the position of said branch metric relative to the edges of said stripe, for instance, the weights for branch bits that are far away from the output bit-row at one side of the stripe, may be set to low values;

each term in the branch metric may be weighted by a transition-dependent and cluster-dependent noise variance, said weighing combating the influence of signal-dependent noise where the weights in the branch metric of all bit-rows within said stripe, are put equal to each other.

A bit-detection method for bit-detection on a 2D array of bits, arranged on a regular 2D lattice, preferably an hexagonal bit-lattice, that is based on a stripe-wise bit-detector, in which the branch metrics, which reflect a sum of squared differences or absolute values of differences or any other applicable norm on a set of differences, said difference being computed between a received or observed sample of the signal waveform and a properly determined noise-free reference level that is typical for the branch considered, said branch metrics apply for each of the possible state-transitions along the associated trellis of the Viterbi processing, said branch metrics are generalized with respect to the following aspects:

each stripe processes a number of bit-rows simultaneously, but has only as output the bit-row at one of its boundaries. The branch metric computation is extended to include the signal waveform samples from the bits in the neighbouring bit-row just exterior to the stripe, and at the side of the output bit-row of the stripe, since the signal energy of the output bit-row has leaked away partly into the samples of said exterior bit-row. The bits in said exterior bit-row beyond the stripe, at the side of the output bit-row, are not varied according to the trellis of the Viterbi-detector, but are determined from a previous position of the stripe, when said exterior bit-row was the output bit-row of said previous position of the stripe.

the branch metrics are a sum of separate terms, one term for each branch bit considered to contribute to the branch metrics; each term may have a local weight that depends on the position of said branch metric relative to the edges of said stripe, for instance, the weights for branch bits that are far away from the output bit-row at one side of the stripe, may be set to low values;

each term in the branch metric may be weighted by a transition-dependent and cluster-dependent noise variance, said weighing combating the influence of signal-dependent noise where the weights are iteration-dependent.

a bit-detection method for bit-detection on a 2D array of bits, arranged on a regular 2D lattice, preferably an hexagonal bit-lattice, that is based on a stripe-wise bit-detector, in which stripes are successively processed in a cascaded fashion, starting from the bit-rows in the 2D array of bits that have a considerable higher certainty of bit-reliability, towards the center of the 2D area that is bounded by said two bit-rows of higher bit-reliability.

a bit-detection method for bit-detection on a 2D array of bits, arranged on a regular 2D lattice, preferably an hexagonal bit-lattice, that is based on a stripe-wise bit-detector, in which stripes are successively processed in a cascaded fashion, starting from the bit-rows in the 2D array of bits that have a considerable higher certainty of bit-reliability, towards the center of the 2D area that is bounded by said two bit-rows of higher bit-reliability, where the bit-rows with high bit-reliability are the guard bands of a broad spiral that contain bits that are a-priori known to the bit-detector.

a bit-detection method for bit-detection on a 2D array of bits, arranged on a regular 2D lattice, preferably an hexagonal bit-lattice, that is based on a stripe-wise bit-detector, in which stripes are successively processed in a cascaded fashion, starting from the bit-rows in the 2D array of bits that have a considerable higher certainty of bit-reliability, towards the center of the 2D area that is bounded by said two bit-rows of higher bit-reliability, where the bit-rows with high bit-reliability are the guard bands of a broad spiral that contain bits that are a-priori known to the bit-detector, where the bits in the guard band are all set to the same binary bit-value.

a bit-detection method for bit-detection on a 2D array of bits, arranged on a regular 2D lattice, preferably an hexagonal bit-lattice, that is based on a stripe-wise bit-detector, in which stripes are successively processed in a cascaded fashion, starting from the bit-rows in the 2D array of bits that have a considerable higher certainty of bit-reliability, towards the center of the 2D area that is bounded by said two bit-rows of higher bit-reliability, where one of the bit-rows with high bit-reliability is a bit-row that is part of a band of bit-rows that has been additionally channel coded to have good transmission properties over the channel.

a bit-detection method for bit-detection on a 2D array of bits, arranged on a regular 2D lattice, preferably an hexagonal bit-lattice, that is based on a stripe-wise bit-detector, in which stripes are successively processed in a cascaded fashion, starting from the bit-rows in the 2D array of bits that have a considerable higher certainty of bit-reliability, towards the center of the 2D area that is bounded by said two bit-rows of higher bit-reliability, where one of the bit-rows with high bit-reliability is a bit-row that is part of a band of bit-rows that has been additionally channel coded to have good transmission properties over the channel, where said band of bit-rows comprises exactly one bit-row.

a bit-detection method for bit-detection on a 2D array of bits, arranged on a regular 2D lattice, preferably an hexagonal bit-lattice, that is based on a stripe-wise bit-detector, in which stripes are successively processed in a cascaded fashion, starting from the bit-rows in the 2D array of bits that have a considerable higher certainty of bit-reliability, towards the center of the 2D area that is bounded by said two bit-rows of higher bit-reliability, where one of the bit-rows with high bit-reliability is a bit-row that is part of a band of bit-rows that has been additionally channel coded to have good transmission properties over the channel, where said band of bit-rows comprises exactly one bit-row, where said bit-row with high bit-reliability is channel encoded with a runlength-limited modulation code.

a bit-detection method for bit-detection on a 2D array of bits, arranged on a regular 2D lattice, preferably an hexagonal bit-lattice, that is based on a stripe-wise bit-detector, in which stripes are successively processed in a cascaded fashion, starting from the bit-rows in the 2D array of bits that have a considerable higher certainty of bit-reliability, towards the center of the 2D area that is bounded by said two bit-rows of higher bit-reliability, where one of the bit-rows with high bit-reliability is a bit-row that is part of a band of bit-rows that has been additionally channel coded to have good transmission properties over the channel, where said band of bit-rows comprises exactly one bit-row, where said bit-row with high bit-reliability is channel encoded with a runlength-limited modulation code, where said runlength-limited modulation code staisfies the d=1 runlength constraint.

1. A symbol detection method for detecting the symbol values of a data block recorded along an N-dimensional channel tube, N being at least 2, on a record carrier of a set of symbol rows, one dimensionally evolving along a first direction and being aligned with each other along at least a second of N-1 other directions, said first direction together with said N-1 other direction constituting an N-dimensional lattice of symbol positions, the method comprising iterative stripe by stripe application of a symbol detection step, wherein a stripe is a subset of at least a row and one neighboring row, the iteration of said stripe wise iterative based symbol detection comprises:
estimating symbol values in a first stripe, side information derived from at least one row adjacent to said current subset being used in the estimation of said symbol values,
processing a second stripe using side information derived from the first stripe
characterized in that the iterative algorithm is applied using a first subset of symbol detectors starting from a guard band delimiting the N-dimensional channel tube and comprising data that can be retrieved with high reliability and a second subset of symbol detectors starting from a further guard band delimiting the N-dimensional channel tube and comprising further data that can be retrieved with high reliability.

2. A symbol detection method as claimed in claim 1, haracterized in that the data that can be retrieved with high reliability is predefined data.

3. A symbol detection method as claimed in claim 1, characterized in that the data that can be retrieved with high reliability is protected using redundant coding.

4. A symbol detection method as claimed in claim 1,
characterized in that the first subset of detectors operates at least partially at the same time as the second subset of detectors.

5. A symbol detector comprising a first detector comprising estimation means for estimating symbol values in a first stripe, receiving means for receiving side information derived from at least one row adjacent to the first stripe, coupled to the estimation means for providing said side information to the estimation means for use in the estimation of said symbol values and output means for providing further side information, and a second detector comprising further estimation means for estimating symbol values in a second stripe, further receiving means for receiving side information derived from the output of the first detector coupled to the further estimation means for providing said side information to the further estimation means for use in the estimation of said symbol values from the second stripe.

6. A playback device comprising a symbol detector as claimed in claim 5.

7. A computer program using the method of claim 1.
